(19) United States
(12) Patent Application Publication
(10) Pub. No.: US 2001/0013856 A1
(43) Pub. Date: Aug. 16, 2001

(54) VIDEO DISPLAY APPARATUS AND METHOD OF PREVENTING INADVERTENT SWITCH-OFF OF LIGHT SOURCE THEREIN

(76) Inventors: KUNIO HAMAKADA, SAITAMA (JP); GENICHIRO KUBOJI, TOKYO (JP); NOBOUO HASEGAWA, TOKYO (JP); OSAMU SUGIYAMA, TOKYO (JP); HARUNA MASUOKA, KANAGAWA (JP); RYUICHI YODA, KANAGAWA (JP); SHIGEKI OHNO, GIFU (JP)

Correspondence Address: JAY H MAIOLI, COOPER AND DUNHAM, 1185 AVENUE OF THE AMERICAS, NEW YORK, NY, 10036

(21) Appl. No.: 09/169,298

(22) Filed: Oct. 9, 1998

(30) Foreign Application Priority Data
Oct. 14, 1997 (JP) P09-280302

(51) Int. Cl. G09G 5/00

(52) U.S. Cl. 345/156

(57) ABSTRACT

A video display apparatus comprising a video display device for visually presenting a video image thereon; a light source turned on by discharge and displaying the video image, which is being presented visually on the video display device, on a screen by irradiation of light; and a system controller for putting out the light source after a lapse of a predetermined delay time from input of a command to switch off a power source. There is also provided a method of preventing inadvertent switch-off of the light source in such a video display apparatus. Even if the power source is switched off inadvertently, the light source is not put out at once and the video image can still be displayed continuously thereon by switching on a power key immediately within the predetermined delay time.

### BACKGROUND OF THE INVENTION

1. Field of the Invention

The present invention relates to improvements in a video display apparatus such as a television receiver, a monitor or a video projector, and also in a method of preventing inadvertent switch-off of a light source in such a video display apparatus.

2. Description of the Related Art

In the category of video display apparatus (also termed video projection apparatus), there are included a television receiver, a video monitor and a video projector as described.

In any of the video display apparatus mentioned, a video image is visually presented on a video display device such as a liquid crystal display unit for example, and then the video image is enlarged and displayed on a screen with projection of outgoing light of a light source from behind the liquid crystal display unit.

For example, a liquid crystal rear projection television receiver employing a liquid crystal display unit is adapted for achieving a wider screen with reduction of its depth, so that a larger-sized screen is easily realizable as compared with an ordinary television receiver employing a cathode-ray tube.

A light source used in such a video display apparatus consists of a lamp which utilizes discharge. In a lamp of this type, a gas is enclosed between electrodes and is caused to emit light by discharge between the electrodes. In case a power source for this lamp is in an off-state, the gas between the electrodes of the lamp is dispersed uniformly. And when the power source is switched on to energize the lamp, a high AC voltage is applied thereto, whereby the gas is ionized between the electrodes to start emission of light. And thereafter the gas is placed in a steady state of emission as the high voltage is lowered.

However, there may occur a case where, in a lamp of this type, the gas is not ionized properly despite application of a high AC voltage and consequently fails to emit light. In this state, it is necessary, for lighting the lamp again, to once switch off the power source for the lamp and then to wait awhile until the inter-electrode gas is dispersed uniformly.

No problem arises if a user completely switches off the power source for the lamp intentionally before going to bed or going out. But if the user inadvertently turns off the lamp while watching television on the video display apparatus by carelessly touching a power key of a remote controller for example, the lamp cannot be turned on immediately as described even if the user tries to light up the lamp by switching on the power key again, and consequently the user needs to wait for 30 seconds or so until next lighting of the lamp. Thus, there exists a problem of serious inconvenience in use.

### SUMMARY OF THE INVENTION

It is therefore an object of the present invention to provide a video display apparatus where, despite inadvertent switch-off of a power source, a light source turned on by discharge is not put out at once and video images can still be displayed continuously thereon by switching on a power key immediately.

And another object of the present invention is to provide a method of preventing inadvertent switch-off of a light source in such a video display apparatus.

According to an aspect of the present invention, there is provided a video display apparatus which comprises a video display device for visually presenting a video image thereon; a light source turned on by discharge and displaying the video image, which is being presented visually on the video display device, on a screen by irradiation of light; and a system controller for putting out the light source after a lapse of a predetermined delay time from input of a command to switch off a power source.

And according to another aspect of the present invention, there is provided a method of preventing inadvertent switch-off of a light source in such a video display apparatus, wherein, when a video image is being presented visually on the video display device, the light source is turned on and lighted by discharge, so that the video image on the video display device is displayed on the screen by the light source. In this case, the system controller functions to put out the light source after a lapse of a predetermined delay time from switch-off of the power source.

Consequently, when the power source is switched off, the light source is not put out at once and then is turned off after a lapse of a predetermined delay time. Therefore, even if a user of the video display apparatus inadvertently switches off the power source in error, the light source being lighted by discharge is held in its on-state when the power source is switched on immediately, so that the video display state can be maintained continuously to attain remarkable convenience in use.

In the present invention, both video and audio outputs are muted by the system controller in response to switch-off of the power source, and the light source is put out after a lapse of the delay time from switch-off of the power source. Thus, in case the user inadvertently switches off the power source in error, the video and audio outputs are muted, and therefore the user is enabled to immediately discern such erroneous unintentional switch-off of the power source. Accordingly, if the user switches on the power source again upon such discernment, it becomes possible to eliminate inadvertent turn-off of the light source being lighted by discharge.

The above and other features and advantages of the present invention will become apparent from the following description which will be given with reference to the illustrative accompanying drawings.

### BRIEF DESCRIPTION OF THE DRAWINGS

FIG. 1 is a perspective view of an embodiment representing a video display apparatus of the present invention;

FIG. 2 is a perspective view showing an exemplary internal structure of the video display apparatus in FIG. 1;

FIG. 3 shows exemplary internal circuits of the video display apparatus in FIG. 1 inclusive of a system controller, a lamp, a screen and so forth;

FIG. 4 is a flowchart showing a processing routine executed in response to switch-off of a power source by a user; and

FIG. 5 is a flowchart showing another processing routine executed in response to switch-on of the power source by the user.

### DETAILED DESCRIPTION OF THE PREFERRED EMBODIMENT

Hereinafter a preferred embodiment of the present invention will be described in detail with reference to the accompanying drawings.

Since the following embodiment is a preferred example of the invention, a variety of technically desirable restrictions are incidental thereto. However, the scope of the invention is not limited to such embodiment alone unless otherwise specified in the following description relative to any particular limitation of the invention.

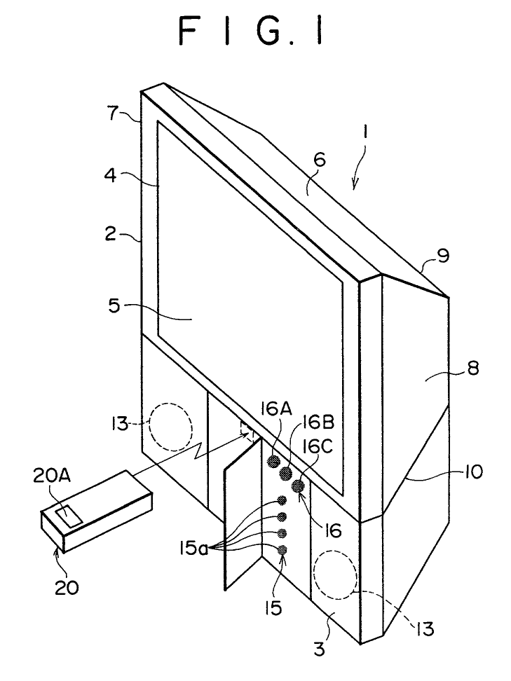

FIG. 1 is a perspective view of a preferred embodiment representing a video display apparatus of the present invention. This diagram illustrates a rear projector termed a liquid crystal rear projection television receiver.

The rear projector 1 has an upper cabinet 2 and a lower cabinet 3.

In the upper cabinet 2, a rectangular frame 4 is formed on its front, and a screen 5 is attached to the frame 4.

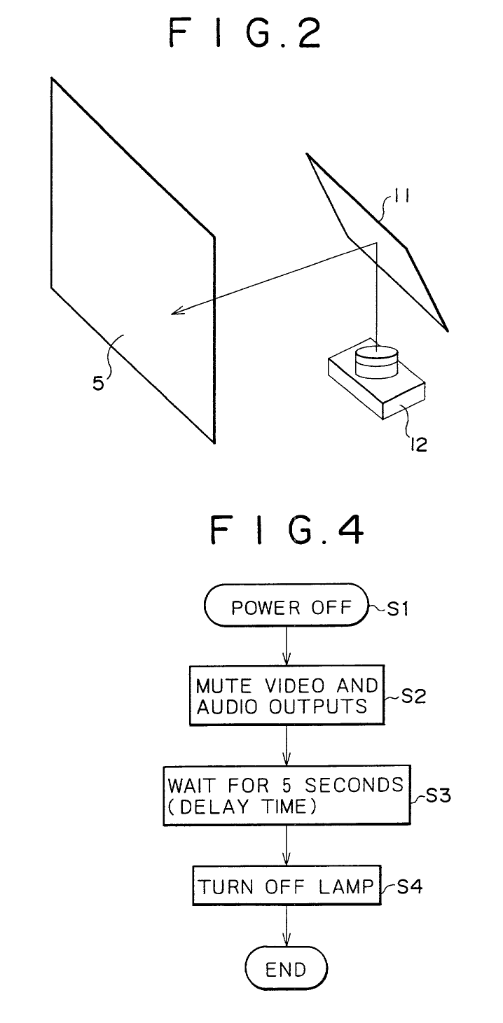

The upper cabinet 2 is shaped into a box with a top wall 6, side walls 7, 8, a back wall 9 and a bottom wall 10, and has an internal cavity with an enclosed periphery. And a mirror 11 shown in FIG. 2 is disposed in the upper cabinet 2. The screen 5 serving as a display plane is disposed on the front of the mirror 11. The mirror 11 is positioned obliquely at a predetermined angle to the screen 5.

The lower cabinet 3 in FIG. 1 houses a projector 12 and other devices therein in addition to the screen 5 and the mirror 11. On the front of the lower cabinet 3, there are disposed speakers 13, 13, a manipulator 15, an error display 16 and so forth. The manipulator 15 has a plurality of manipulation buttons 15a. And the error display 16 has a plurality of, e.g., light emitting diodes (LED) 16A, 16B, 16C and so forth.

The rear projector 1 is equipped with a wireless remote controller 20.

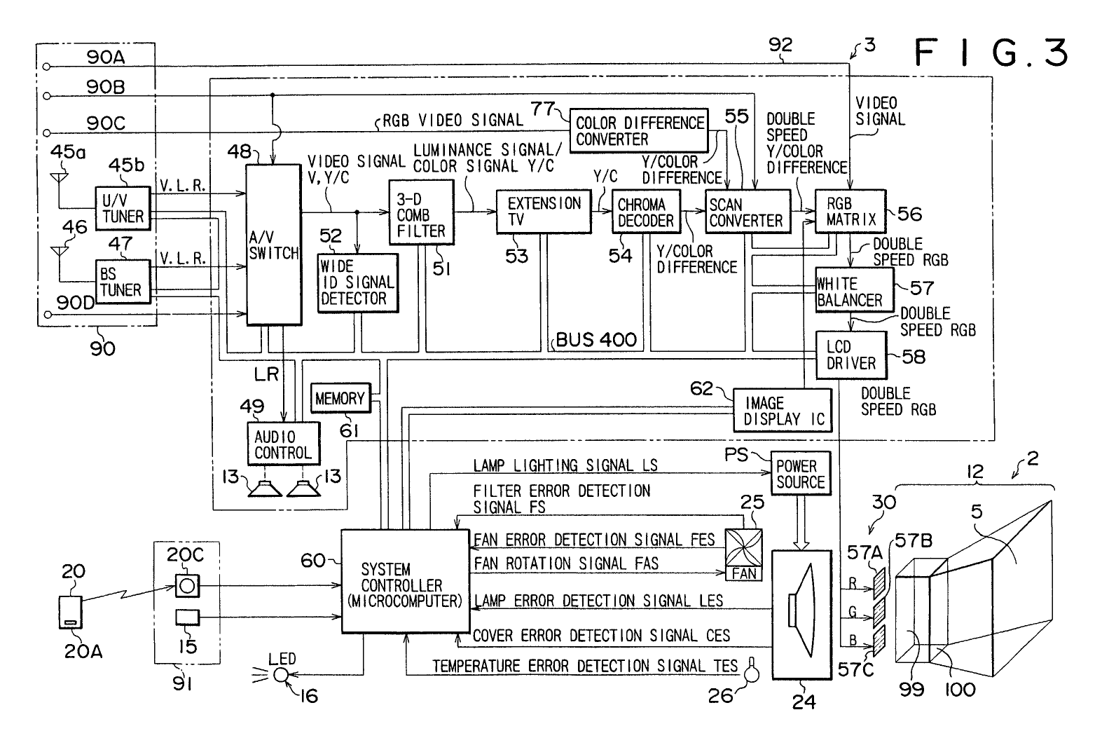

FIG. 3 shows an exemplary internal structure of the upper cabinet 2 and the lower cabinet 3 in FIG. 1.

The lower cabinet 3 houses a projector 12, which has a liquid crystal display device 30 corresponding to R (red), G (green) and B (blue). This liquid crystal display device 30 serves as a video display unit for visually presenting video images, and a prism 99 and a lens system 100 are interposed between the liquid crystal display device 30 and the screen 5. The prism 99 composites the images presented respectively on a liquid crystal panel 30A for R (red), a liquid crystal panel 30B for G (green) and a liquid crystal panel 30C for B (blue) of the liquid crystal display device 30, and then the lens system 100 enlarges the composite image and projects the same onto the screen 5. In this case, the composite video image on the liquid crystal display device 30 is displayed in an enlarged size on the screen 5 through projection thereto with irradiation of the light from a lamp 24 which serves as a light source in the lower cabinet 3 mentioned later.

Next, an exemplary circuit configuration housed in the lower cabinet 3 of FIG. 1 will be described below with reference to FIG. 3.

In FIG. 3, the rear projector 1 has the following circuit configuration.

The configuration of FIG. 3 comprises signal inputs 90, 91, a signal processor 92 and a system controller 60. The system controller 60 is connected electrically to the signal input 90 and the signal processor 92. The system controller 60 is further connected electrically to a lamp 24 as a light source, a fan 25, a temperature sensor 26 and a power source PS.

The signal input 90 has a DVD (digital video disc or digital versatile disc) input 90A, a high definition television signal (HD) input 90B, an AV (audio-visual) multi input 90C, a U/V antenna 45a, a BS antenna 46 and a video input 90D. The signal input 91 has a signal sensor 20C to receive, e.g., an infrared input signal from a remote controller 20, and a manipulator 15.

The U/V antenna 45a is connected to a U/V tuner 45b. Similarly, the BS antenna 46 is connected to a BS tuner 47.

The signal processor 92 has an A/V switch 48, an audio control 49, speakers 13, 13, a 3-D comb filter 51, a wide ID signal detector 52, an extension TV 53, a chroma decoder 54, a scan converter 55, an RGB matrix 56, a white balancer 57, an LCD driver 58, a memory 61 and an image display IC (integrated circuit) 62.

The system controller 60 consists of a system microcomputer for example and is connected electrically to the aforementioned U/V tuner 45b, BS tuner 47, A/V switch 48, wide ID signal detector 52, 3-D comb filter 51, extension TV 53, chroma decoder 54, scan converter 55, RGB matrix 56, white balancer 57, driver 58, memory 61, audio control 49 and image display IC 62 via a bus 400.

The sensor 20C and the manipulator 15 of the signal input 91 are connected to the system controller 60. The LEDs 16A-16C of the error display 16 shown in FIGS. 1 and 3 are mutually combined for display in accordance with a command from the system controller 60.

The U/V tuner 45b selects a desired station out of terrestrial wave signals received by the U/V antenna 45a, and the BS tuner 47 selects a desired station out of satellite broadcast signals received by the BS antenna 46.

The A/V switch 48 inputs video signals (V) and audio signals (L, R) obtained through the U/V tuner 45b and the BS tuner 47 and demodulated thereafter, and also video signals (V) and audio signals (L, R) obtained from the video input 90D, and then outputs one selected signal.

The audio control 49 controls the left and right audio signals (L, R) selected by the A/V switch 48 and then emits the audio signals from the left and right speakers 13, 13.

The video signal obtained from the HD input 90B and recorded on a hard disk is supplied to the RGB matrix 56, while the audio signal is supplied to the A/V switch 48. The video signal from the AV multi input 90C is supplied to a color difference converter 77, while a Y (luminance)/color difference signal is supplied to the scan converter 55, and the audio signal is supplied to the A/V switch 48.

The A/V switch 48 selects the input signal and then outputs the video signal to the 3-D comb filter 51.

The 3-D comb filter 51 inputs the video signal selected by the A/V switch 48 and, after separating the video signal into a luminance signal and a color signal (Y/C), outputs the same therefrom.

The wide ID signal detector 52 detects, out of the video signal selected by the A/V switch 48, the wide ID signal superimposed in the vertical blanking interval.

The extension TV 53 detects an extension television ID control signal and decodes a reinforced signal out of the luminance signal and the color signal extracted through the 3-D comb filter 51, and then outputs such signals to the chroma decoder 54.

The chroma decoder 54 demodulates the luminance signal and the color signal of the video signal obtained by decoding the ID control signal and the reinforced signal in the extension TV 53, thereby obtaining demodulated Y/color difference signal.

The scan converter 55 converts the Y/color difference signal into double speed signal since the signals demodulated in the chroma decoder 54 are not suited for interlaced scanning in the use of the liquid crystal display device 30, and further executes zooming for example by converting the aspect ratio of the image display from 4:3 to 16:9.

The RGB matrix 56 converts the double-speed Y/color difference signal outputted from the scan converter 55 into double-speed RGB signal and switches the same with the video signal obtained from the HD input 90B, and further inputs the screen display RGB signal obtained from the image display IC 62 and then superimposes the same on the video RGB signal.

The white balancer 57 executes white balance adjustment of the RGB signal speed-doubled by the scan converter 55 and superimposed by the RGB matrix 56.

The LCD driver 58 supplies the double-speed RGB signal processed through white balance adjustment by the white balancer 57 to three LCD panels 57A, 57B, 57C to control the same.

On the screen 5, there are visually presented the three LCD panels 57A, 57B, 57C for R, G, B and also the video image having passed therethrough with the light irradiated from the lamp 24.

The entire component elements of the apparatus are under control of the system controller 60 via the bus 400, and the system controller 60 executes various control actions in accordance with channel select information inputted thereto via the bus 400 from the remote controller 20 or the manipulator 15 operated by the user.

In the memory 61 connected to the bus 400, there are stored data required for the system controller 60 to execute its various control actions. For example, such data include those relative to desired picture mode, channel, input switching and sound volume specified by the user, and also data for adjustment of picture distortion and so forth.

Meanwhile the system controller 60 executes on/off control of the lamp 24, the fan 25 and the LEDs 16A, 16B, 16C of the error display 16.

The system controller 60 controls an error detection mechanism provided for detecting any abnormal error state relative to the filter, fan, lamp and temperature.

The error detection mechanism actuated by the system controller 60 detects various error states and also performs other operations of switching off the power source and so forth upon detection of any abnormal error state and executes required display corresponding to each error state.

Display of each abnormal error state is represented by a combination of the three LEDs 16A, 16B, 16C of the error display 16 provided on the front of the liquid crystal projection television 1. Normally, these LEDs 16A, 16B, 16C serve to display the current state of the power source. For example, the power LED 16A is turned on when the power source is switched on. The standby LED 16B is turned on when the set power source is in a standby mode. And the BS power LED 16C is turned on when the BS power source is switched on. Any individual error state is displayed by means of such LEDs 16A, 16B, 16C.

The system controller 60 instructs the image display IC 62 via the bus 400 to output the image display RGB signal, thereby executing superimposed display and so forth on the screen 5 shown in FIGS. 1 and 2.

Now an explanation will be given on various abnormal error states with reference to FIG. 3.

The lamp 24 is a type caused to emit light by discharge as will be described later. Since heat is generated in this lamp 24 with emission of light, it is necessary to cool the lamp 24 by means of the fan 25.

In case the lamp 24 is abnormal, there may occur a trouble that the lamp fails to be turned on because of its structure where emission of light is caused by discharge. In another case, the lamp 24 may not be lighted any longer due to expiration of its service life. A lamp error detection signal LES is sent from the lamp 24 to the system controller 60, whereby an off-state of the lamp 24 is detected.

As the lamp 24 has a service life, the apparatus is so constructed as to enable the user to open the cover and replace the lamp 24 with a new one upon expiration of its service life. When the cover of the lamp 24 is opened for replacement of its unit inclusive of the lamp 24 itself, a cover error detection signal CES for the lamp 24 is sensed to detect that the cover is open.

A fan error detection signal FES is sensed to detect any improper rotation of the fan 25 when the fan 25 fails to be rotated properly for some reason.

A filter error detection signal FS is used in the following case. The fan 25 serves to cool the unit of the lamp 24 while sending air thereto, but when some dirt or dust is sent into this unit together with air, it causes malfunction of the lamp 24. For the purpose of avoiding such trouble, a filter is employed to eliminate any dirt or dust. However, dirt or dust is gradually accumulated on the filter with a lapse of time to consequently deteriorate passage of air. It is therefore necessary to remove the accumulated dirt or dust after taking off the filter. The filter error detection signal FS is sensed to detect that the filter has been taken off.

A temperature error detection signal TES is used in the following case. Even if the fan 25 keeps cooling the unit, there still exists a possibility that the temperature in the unit rises to be abnormally high. Such condition is derived from abnormal generation of heat in the lamp 24 or from insufficient cooling by the fan 25. In this case, a temperature error detection signal TES is sent to the system controller 60 so that the abnormally high temperature in the unit can be detected.

In addition to the above, a fan rotation signal FAS is sent from the system controller 60 to the fan 25 so as to rotate the fan 25 at a predetermined rate. And a lamp lighting signal LS is sent from the system controller 60 to the lamp 24 so as to turn on the lamp 24.

Next, an explanation will be given on the lamp 24. A gas is enclosed between electrodes of the lamp 24 consisting of a high-intensity lamp or the like, and the gas emits light as a result of inter-electrode discharge.

If the system controller 60 does not send a lamp lighting signal LS to the power source PS for the lamp, the power source PS is switched off, and the gas between the electrodes is dispersed uniformly in such off-state of the power source PS. The operation for turning on the lamp 24 is started in response to a lamp lighting signal LS from the system controller 60, and a high AC voltage of ±25 kV is applied. Then the gas is ionized between the electrodes so that the lamp 24 begins emission of light. And when the high AC voltage is subsequently lowered to a predetermined value, the lamp 24 is placed in a steady state of light emission.

At this time, there may occur a case where the gas fails to be ionized properly and therefore emits no light despite application of a high AC voltage of ±25 kV. This abnormal state represented by a lamp error detection signal LES of FIG. 3 is inputted to the system controller 60. In this case, the system controller 60 waits for awhile without sending the lamp lighting signal LS to the lamp 24, because the operation for turning on the lamp 24 cannot be restarted until the inter-electrode gas in the lamp 24 is dispersed uniformly.

If any AC interruption happens during the on-state of the lamp 24, there may occur a case where the high AC voltage that causes discharge between the electrodes is lowered to consequently turn off the lamp 24. In this condition, a lamp error detection signal LES is inputted to the system controller 60. At this time also, the system controller 60 waits for awhile without sending a lamp lighting signal LS to the power source PS because the operation for turning on the lamp 24 again cannot be started until the inter-electrode gas is dispersed uniformly.

As for the waiting time required to achieve uniform dispersion of the inter-electrode gas, 30 seconds are necessary after the power source is switched off during the on-state of the lamp 24. In case the operation for turning on the lamp 24 again fails to be started, a time of 15 seconds or so is required until turning on the lamp 24 again, since the gas is still being ionized halfway.

No problem arises in case the user switches off the power source intentionally before going to bed or going out for example. However, if the user depresses the power key 20A of the remote controller 20 inadvertently while watching television on the screen 5 of the rear projector 1 in FIG. 1, it is possible for the user to prevent unintentional turn-off of the lamp 24 by depressing again the power key 20A of the remote controller 20 in the following manner, whereby the television on the screen 5 can still be watched continuously.

The liquid crystal panels 57A, 57B and 57C shown in FIG. 3 relative to R (red), G (green) and B (blue) respectively are disposed opposite to a compositing element such as a prism. Video images formed on the liquid crystal panels 57A, 57B, 57C of the liquid crystal display device (video display device) are composited by the prism 99, which serves as a compositing element, due to the light emitted from the lamp 24 disposed behind, and then are displayed on the screen 5 after being enlarged by a magnifying lens 100.

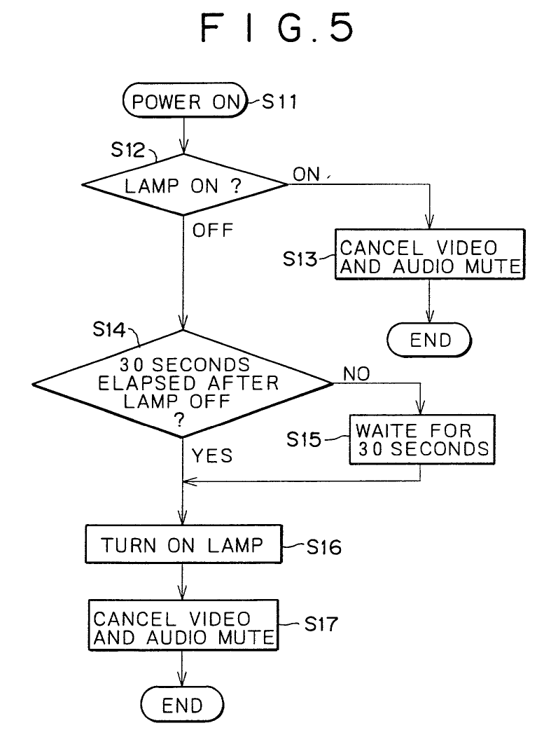

Referring now to FIGS. 4 and 5, an explanation will be given on the operations performed in response to turning on and turning off the power source.

First, FIG. 4 will be referred to. This flowchart shows an exemplary case where the user has depressed the power key 20A of the remote controller 20 in the rear projector 1 before going to bed or going out, or the user has depressed inadvertently the power key 20A of the remote controller 20 while watching television on the screen 5.

At step S1 of FIG. 4 where the user depresses the power key 20A of the remote controller 20 in FIG. 3, the sensor 20C senses such depression of the power key 20A so that the system controller 60 recognizes switch-off of the power source. Subsequently the system controller 60 sends a signal to the audio control 49 to mute (interrupt) the audio output from the speaker 13 while sending another signal to the image display IC 62 to mute (interrupt) the video output (step S2).

Thereafter at step S3, the system controller 60 waits for a predetermined delay time of, e.g., 5 seconds and then stops sending a lamp lighting signal LS to the power source PS, whereby the lamp 24 is turned off as shown at step S4.

Thus, when the user switches off the power source intentionally at the time of going to bed or going out for example, the processes at steps S1-S4 of FIG. 4 are executed to mute both video and audio outputs, and emission of light from the lamp 24 is brought to a halt after a lapse of the predetermined delay time.

At step S11 of FIG. 5 where the power key 20A is depressed to switch on the power source, the system controller 60 recognizes that the power source has been switched on by the depression of the power key 20A in the remote controller 20. Subsequently at step S12, the system controller 60 makes a decision as to whether the lamp 24 is in its on-state or not, on the basis that a lamp lighting signal LS is sent to the power source PS and that a lamp error detection signal LES is not sent from the lamp 24. If the result of the decision at step S12 signifies that the lamp 24 is in its on-state, the operation proceeds to step S13, where the system controller 60 sends a signal to the audio control 49 and the image display IC 62 to thereby cancel both the video mute (picture mute) and the audio mute. Consequently, the audio output is emitted from the speakers 13, while the video output is projected onto the screen 5.

If the result of the decision at step S12 signifies that the lamp 24 is in its off-state, the operation proceeds to step S14, where the system controller 60 makes a decision as to whether a predetermined delay time of, e.g., 30 seconds has elapsed or not after the lamp 24 is turned off. And if the result of the decision at step S14 signifies no elapse of 30 seconds, the system controller 60 waits at step S15 until elapse of the delay time of 30 seconds.

After elapse of 30 seconds at step S15 or in case the result of the decision at step S14 signifies that 30 seconds have already elapsed, the operation proceeds to step S16, where the system controller 60 sends a lamp lighting signal LS to the power source PS to thereby turn on the lamp 24. And thereafter at step S17, the system controller 60 sends a signal to both the audio control 49 and the image display IC 62 to cancel both the video mute and the audio mute.

At steps S1-S3 in FIG. 4, as described above, the operation waits for a predetermined delay time of, e.g., 5 seconds after video mute and audio mute are executed in response to switch-off of the power source by the user, so that it becomes possible to prevent simultaneous turn-off of the lamp 24 with such switch-off of the power source. Therefore, at the time point after wait for 5 seconds from switch-off of the power source, the lamp 24 is turned off unless the user depresses the power key 20A of the remote controller 20 again to switch it on, and then supply of a lamp lighting signal LS is brought to a halt at step S4 to turn off the lamp 24.

Thus, even in case the user inadvertently depresses the power key 20A of the remote controller 20 while watching television on the screen 5, both video mute and audio mute are executed immediately so that the user can notice his erroneous unintentional depression of the power key 20A. Therefore, if the user immediately switches on the power key 20A again from the off-state within a lapse of 5 seconds, the system controller 60 keeps sending the lamp lighting signal LS continuously to the power source PS, hence preventing a phenomenon that the lamp 24 is put out.

In this manner, if the power key 20A in its off-position is switched on again by the user, both the video mute and the audio mute can be canceled and the lamp 24 is still kept in the on-state without being put out, so that the video image can be projected onto the screen 5. Thus, if the user manipulates the power key 20A to switch on the same, it becomes possible to emit both video and audio outputs immediately without putting out the lamp 24, hence achieving enhanced convenience in use.

In the embodiment mentioned above, the delay time is set to 5 seconds at step S3 in FIG. 4. However, the delay time is not limited merely to 5 seconds alone, and it is selectively settable to any value of 0, 5, 10, 15, 20, 25, 30, . . . seconds. It is a matter of course that such setting may be previously incorporated in the system controller 60, or a desired delay time may be set by the use of a program. Thus, differing from the conventional known case where 30 seconds are required for turning on the lamp 24 again if the lamp is inadvertently turned off by erroneous unintentional depression of the power key 20A, such a wait time is no longer necessary to consequently enhance the convenience in using the rear projector 1.

It is to be understood that the present invention is not limited only to the embodiment mentioned.

In the above embodiment, the video display apparatus is a type that employs a liquid crystal panel and projects light of a lamp from behind the liquid crystal panel. However, the type is not limited thereto alone, and some other type may be adopted as well.

The contents of video images to be displayed on the screen may be a program displayed on a television receiver, or some ordinary video images used for the purpose of presentation or the like.

What is claimed is:

1. A video display apparatus comprising:
a video display device for visually presenting a video image thereon;
a light source turned on by discharge and displaying the video image, which is being presented visually on said video display device, on a screen by irradiation of light; and
a system controller for putting out said light source after a lapse of a predetermined delay time from input of a command to switch off a power source.

2. The video display apparatus according to claim 1, wherein said system controller prevents switch-off of the light source when a command for switching on the power source again is inputted within a predetermined delay time from input of a command to switch off the power source.

3. The video display apparatus according to claim 1, wherein said system controller executes video mute and audio mute at the time to switch off the power source, and puts out said light source after a lapse of a predetermined delay time therefrom.

4. The video display apparatus according to claim 3, wherein said system controller cancels the video mute and the audio mute when a command for switching on the power source again is inputted within a predetermined delay time, and then prevents switch-off of the light source.

5. The video display apparatus according to claim 1, wherein said light source is a high intensity lamp, and said video display device is a liquid crystal display unit.

6. The video display apparatus according to claim 1, wherein said delay time is settable to any desired value by said system controller.

7. The video display apparatus according to claim 1, wherein said delay time is set previously in said system controller.

8. A method of preventing inadvertent switch-off of a light source in a video display apparatus where a video image being visually presented on a video display device is displayed on a screen with irradiation of light from the light source turned on by discharge, said method characterized by enabling a system controller to put out said light source after a lapse of a predetermined delay time from input of a command to switch off a power source.

9. The method according to claim 8 for preventing inadvertent switch-off of a light source in a video display apparatus, wherein said system controller prevents switch-off of the light source when a command for switching on the power source again is inputted within a predetermined delay time from input of a command to switch off the power source.

10. The method according to claim 8 for preventing inadvertent switch-off of a light source in a video display apparatus, wherein said controller executes video mute and audio mute at the time to switch off the power source, and puts out said light source after a lapse of a predetermined delay time therefrom.

11. The method according to claim 10 for preventing inadvertent switch-off of a light source in a video display apparatus, wherein said system controller cancels the video mute and the audio mute when a command for switching on the power source again is inputted within a predetermined delay time, and then prevents switch-off of the light source.

12. The method according to claim 8 for preventing inadvertent switch-off of a light source in a video display apparatus, wherein said light source is a high intensity lamp, and said video display device is a liquid crystal display unit.

13. The method according to claim 8 for preventing inadvertent switch-off of a light source in a video display apparatus, wherein said delay time is settable to any desired value by said system controller.

14. The method according to claim 8 for preventing inadvertent switch-off of a light source in a video display apparatus, wherein said delay time is set previously in said system controller.
